(19) United States
(12) Patent Application Publication
(10) Pub. No.: US 2009/0019412 A1
(43) Pub. Date: Jan. 15, 2009

(54) DESIGN METHOD AND DESIGN APPARATUS FOR SEMICONDUCTOR INTEGRATED CIRCUIT

(76) Inventors: Masahiro Yoshimura, Tokyo (JP); Noriko Iijima, Kanagawa (JP); Muneaki Kyoya, Kanagawa (JP); Ryo Nakanishi, Kanagawa (JP); Tetsuji Shiokawa, Kanagawa (JP); Satoru Nishioka, Kanagawa (JP)

Correspondence Address: MCDERMOTT WILL & EMERY LLP, 600 13TH STREET, NW, WASHINGTON, DC, 20005-3096, US

(21) Appl. No.: 12/170,538

(22) Filed: Jul. 10, 2008

(30) Foreign Application Priority Data
Jul. 10, 2007 (JP) P.2007-180891

(51) Int. Cl. G06F 17/50

(52) U.S. Cl. 716/9

(57) ABSTRACT

According to the present invention, timing information, connection information and physical information are received, and at the weighting determination step, the degree to which a cell can move is weighted. Then, at the movement range determination step, the movement enabled range of the cell is determined, and whether or not a cell placement area is available is decided. When it is decided that a cell placement area is available, the processing advances either to the cell movement area extension step or to the cell placement area acquisition step. Thereafter, an automatic, optimal placement process is performed for the cell.

### BACKGROUND OF THE INVENTION

1. Field of the Invention

The present invention relates to a design method and a design apparatus for a semiconductor integrated circuit, and relates particularly to a cell placement method.

2. Description of the Related Art

Conventionally, when a timing violation or an input transition violation has occurred in a semiconductor integrated circuit during the design of a layout, the timing is corrected. According to this conventional method, information for circuit correction and cell placement is created to satisfy timing constraints, and the succeeding process is performed using an automatic placing and wiring tool. Example conventional methods are described in patent documents 1 and 2. According to the method described in patent document 1, locations for the placement of cells are determined by employing cut line partitioning, so that the number of wires that cross a cut line can be minimized. Furthermore, a critical path is extracted, and cells along the critical path and cells to be connected to a net included in the critical path are moved, with the result being that timing constraints are satisfied. According to the method described in patent document 2, a length of wiring extended in a specified direction is predicted based on connection information, and is compared with a reference length to determine a weighting coefficient. The thus obtained weighting coefficient and the resistance per unit length are then employed to calculate a converted resistance, and the converted resistance is employed to satisfy timing constraints.

When a timing or an input transition violation involves the insertion of a cell, the cell to be inserted should be positioned so that its barycenter is aligned with that of a preceding or succeeding cell or with the barycenter of the cell at which the violation occurred. However, according to the conventional cell placement method employed for a timing correction, when in a preferred insertion location cells are already so closely positioned that no free space is available for the insertion of another cell, the insertion location will be shifted to one whereat the insertion of a cell would provide no corrective effect, and if a cell is actually inserted there, deterioration of the timing and wiring would occur. Therefore, in this instance, a visual inspection of the cell placement situation must first be performed, and then, the selection, based on driving capability, and the preparation of placement information must be performed manually.

Patent Document 1: JP-A-8-96013

Patent Document 2: JP-A-2006-260200

When the above described method is employed to perform a timing correction, checking of the placement situation and the selection, based on driving capability, of a cell must be performed manually, so that for the correction process, especially when there are many timing violations, an extended period of time will be required. Furthermore, because the possibility is high an error will be made in the preparation of the placement information file or during the cell selection process, which is based on the driving capability of a cell, a so-called processing setback may occur that will cause the timing and wiring closure periods to be extended. In addition, since the relevant consensus, in consonance with current microstructural semiconductor manufacturing process developments, is that system sizes may be expected to continue to increase, there is general agreement that the closure periods for timing and wiring will become an ever more important problem.

### SUMMARY OF THE INVENTION

While taking the immediately foregoing situations into account, one objective of the present invention is the provision, for a process for performing a timing correction through the insertion of a cell, of information for timing, of information indicating timing correction content and of information for weighting that provides a priority order for the movement of cells, so that these information sets can be employed for placing cells, following a layout design, to avoid wire congestion and to simplify the timing correction process.

According to the present invention, weighting information for a cell movement range is provided based on a timing margin or the Manhattan distance between cells, and the driving capability of a cell that is to be inserted is employed to determine a permissible insertion range relative to an insertion location. Following this, the status of a movement destination or an insertion destination is identified using an algorithm based on a parameter that indicates a cell tiling ratio or wire congestion, and a cell placement process is performed. Thus, it is easy to avoid wire congestion and to perform a timing correction that satisfactorily reflects the intent of the design.

Specifically, according to the present invention, a design method for a semiconductor integrated circuit comprises:

a first weight determination step of first receiving timing information and connection information (hereinafter referred to as a net listing), and of then performing a weighting calculation process during which a movement range for a cell becomes smaller as the weighting for the cell becomes greater, while weighting is significantly enhanced for a cell for which the timing margin is small; and

a cell placement step of placing a cell in accordance with weighting results obtained at the first weight determination step.

With this arrangement, wiring and timing closure can be easily performed within a short period of time.

The design method for a semiconductor integrated circuit further comprises:

a second weighting determination step of performing a weighting calculation process during which a movement range for a cell becomes smaller as the weighting for the cell becomes greater, while the weighting is significantly enhanced for a cell for which, based on physical information, a long Manhattan distance is obtained; and

a cell placement step of placing cells in accordance with the weighting results obtained at the second weighting determination step.

The design method for a semiconductor integrated circuit further comprises:

a third weighting determination step of performing a weighting calculation process during which a movement range for a cell becomes smaller as the weighting for the cell becomes greater, while the weighting is significantly enhanced for a cell for which a large number of fanouts is obtained from a net listing at a physical design step for a semiconductor integrated circuit; and

a cell placement step of placing cells in accordance with weighting results obtained at the third weight determination step.

The design method for a semiconductor integrated circuit further comprises:

a setup step of employing the weighting results obtained at least one of the first to the third weight determination steps to designate a permissible value for a movement range for a cell.

According to this invention, the design method for a semiconductor integrated circuit further comprises:

a storage step of storing the movement range designated at the setup step; and

a determination step of searching for an area, within the permissible value designated for the movement range, whereat the tiling ratio of cells becomes smallest, and determining a movement range for a cell, while avoiding a cell or wiring congested area.

According to this invention, the design method for a semiconductor integrated circuit further comprises:

a change step of employing a signal pin density to change the movement range that is determined at the determination step.

Further, according to this invention, for the design method for a semiconductor integrated circuit, the storage step includes the steps of:

extending the movement range in accordance with a predetermined ratio when an area that satisfies a cell placement condition is not obtained at the change step for changing the movement range based on the signal pin density, and determining an upper limit for the movement range in accordance with the driving capability of a cell; and

determining, within a range extending to the upper limit, a position to which to move the cell.

Furthermore, according to this invention, the design method for a semiconductor integrated circuit comprises a step of:

when an area that satisfies a placement condition is obtained at the change step, identifying a drive capability for a cell based on an area obtained at the storage area, and changing the drive capability to acquire an area for placing the cell.

In addition, according to this invention, the design method for a semiconductor integrated circuit comprises a step of:

when wiring passes through a congested area, reducing the effectiveness of a cell on a reception side, and placing, adjacent to the cell, another cell having an appropriate driving capability.

Moreover, according to this invention, the design method for a semiconductor integrated circuit comprises a step of inserting a repeater cell when a timing margin is high.

Also, according to the design method for a semiconductor integrated circuit, dimensional reduction or logic reduction is performed by preferentially replacing a cell, in a congested location, that has a high timing margin with a low-power driven cell, so that congestion engendered by placing cells is relieved and acquisition of a cell area is ensured.

According to the invention, a design apparatus for a semiconductor integrated circuit comprises:

a first weight determination unit for first receiving timing information and connection information, and for then performing a weighting calculation process during which a movement range for a cell becomes smaller as the weighting for the cell becomes greater, while weighting is significantly enhanced for a cell for which the timing margin is small; and

a cell placement unit for placing a cell in accordance with weighting results obtained by the first weight determination unit.

The design apparatus for a semiconductor integrated circuit further comprises:

a second weighting determination unit for performing a weighting calculation process during which a movement range for a cell becomes smaller as the weighting for the cell becomes greater, while the weighting is significantly enhanced for a cell for which, based on physical information, a long Manhattan distance is obtained,

wherein the cell placement unit places cells in accordance with the weighting results obtained by the first weighting determination unit and second weighting determination unit.

The design apparatus for a semiconductor integrated circuit further comprises:

a third weighting determination unit for performing a weighting calculation process during which a movement range for a cell becomes smaller as the weighting for the cell becomes greater, while the weighting is significantly enhanced for a cell for which a large number of fanouts is obtained from a net listing,

wherein the cell placement unit places cells in accordance with the weighting results obtained by the third weight determination unit and the weighting results obtained by either the first or the second weighting determination unit.

The design apparatus for a semiconductor integrated circuit further comprises:

a movement range setup unit for employing the weighting results obtained by at least one of the first to the third weight determination units to designate a permissible value for a movement range for a cell.

According to this invention, the design apparatus for a semiconductor integrated circuit further comprises:

a movement range storage unit for storing the movement range designated by the movement range setup unit; and

a movement range determination unit for searching for an area, within the permissible value designated for the movement range, whereat the tiling ratio of cells becomes smallest, and for determining a movement range for a cell, while avoiding a cell or wiring congested area.

According to this invention, the design apparatus for a semiconductor integrated circuit further comprises:

a movement range change unit for employing a signal pin density to change the movement range that is determined by the movement range determination unit.

Further, according to this invention, for the design apparatus for a semiconductor integrated circuit, the movement range storage unit includes:

a movement range extension unit for extending the movement range in accordance with a predetermined ratio when an area that satisfies a cell placement condition is not found based on the results obtained by the movement range change unit, and for determining an upper limit for the movement range in accordance with the driving capability of a cell; and

a movement position determination unit for determining, within a range extending to the upper limit, a position to which to move the cell.

Furthermore, according to this invention, the design apparatus for a semiconductor integrated circuit comprises:

a cell placement unit for, when an area that satisfies a placement condition is obtained by the movement range change unit, identifying a drive capability for a cell based on an area obtained by the movement range storage area, and for changing the drive capability to acquire an area for placing the cell.

In addition, according to this invention, for the design apparatus for a semiconductor integrated circuit, when wiring passes through a congested area, the cell placement unit reduces the effectiveness of a cell on a reception side, and places, adjacent to the cell, another cell having an appropriate driving capability.

Moreover, according to this invention, the design apparatus for a semiconductor integrated circuit, the cell placement unit inserts a repeater cell when a timing margin is high.

Also, according to the design apparatus for a semiconductor integrated circuit, dimensional reduction or logic reduction is performed by preferentially replacing a cell, in a congested location, that has a high timing margin with a low-power driven cell, so that congestion engendered by placing cells is relieved and acquisition of a cell area is ensured.

As described above, according to the present invention, the occurrence of wire congestion can be prevented and a timing correction can be easily performed. Furthermore, the number of steps required can be reduced, and a so-called process setback caused by an error in a manual process can be avoided. Therefore, timing closure can be provided in a shorter time period than that which is required for a conventional method.

### BRIEF DESCRIPTION OF THE DRAWINGS

FIG. 1 is a flowchart showing an overview of the processing for the present invention for placing an ECO cell, while taking into consideration a timing and a cell placement/wiring area.

FIG. 2 is a diagram for explaining a Manhattan distance between cells that are elements for a weighting determination.

FIG. 3 is a block diagram illustrating a design apparatus employed for a first embodiment of the present invention.

FIG. 4 is a detailed flowchart showing the process at a weighting determination step in FIG. 1.

FIG. 5 is a diagram for explaining a timing margin between cells that are defining elements for a weighting determination.

FIG. 6 is a diagram for explaining the number of fanouts between cells that are defining elements for a weighting determination.

FIG. 7 is a detailed flowchart showing the process at a movement range determination step in FIG. 1.

FIG. 8 is a detailed flowchart showing the process at a movement range extension step in FIG. 1.

FIG. 9 is a detailed flowchart showing the process at a cell placement/wiring area acquisition step in FIG. 1.

FIGS. 10A and 10B are diagrams illustrating the movement range for a cell in accordance with a weighting determined based on a timing margin.

FIGS. 11A and 11B are diagrams illustrating the density of pins that are defining elements for determining a movement range.

FIG. 12 is a diagram showing the state wherein a movement range is extended at a predetermined ratio at the movement range extension step.

FIGS. 13A and 13B are diagrams showing the state wherein an extendable area differs depending on the cell type at the movement range extension step.

FIGS. 14A and 14B are diagrams showing the state wherein, when a wiring congestion portion is along a path before and after an ECO targeted cell, a measure for considering whether bypassing is feasible for a path (insertion on the reception side of a cell of a low-power driven type) is prepared at the wiring acquisition step.

FIGS. 15A and 15B are diagrams showing the state wherein, when there is a wiring congested portion along a path before or after an ECO targeted cell, a measure for considering whether bypassing is feasible for a path (insertion of a repeater buffer) is prepared at the wiring acquisition step.

FIG. 16 is a diagram illustrating a congested area Ar that is present at the cell placement area acquisition step.

FIG. 17 is a diagram illustrating the state wherein cells are deleted from the congested area in FIG. 16 to obtain space for the placement of a new cell.

FIG. 18 is a detailed flowchart showing the process at a weighting determination step for a second embodiment of the present invention.

FIG. 19 is a detailed flowchart showing the process at a weighting determination step for a third embodiment of the present invention.

FIG. 20 is a detailed flowchart showing the process at a weighting determination step for a fourth embodiment of the present invention.

### DESCRIPTION OF THE PREFERRED EMBODIMENTS

The preferred embodiments of the present invention will now be described in detail, while referring to accompanying drawings.

### First Embodiment

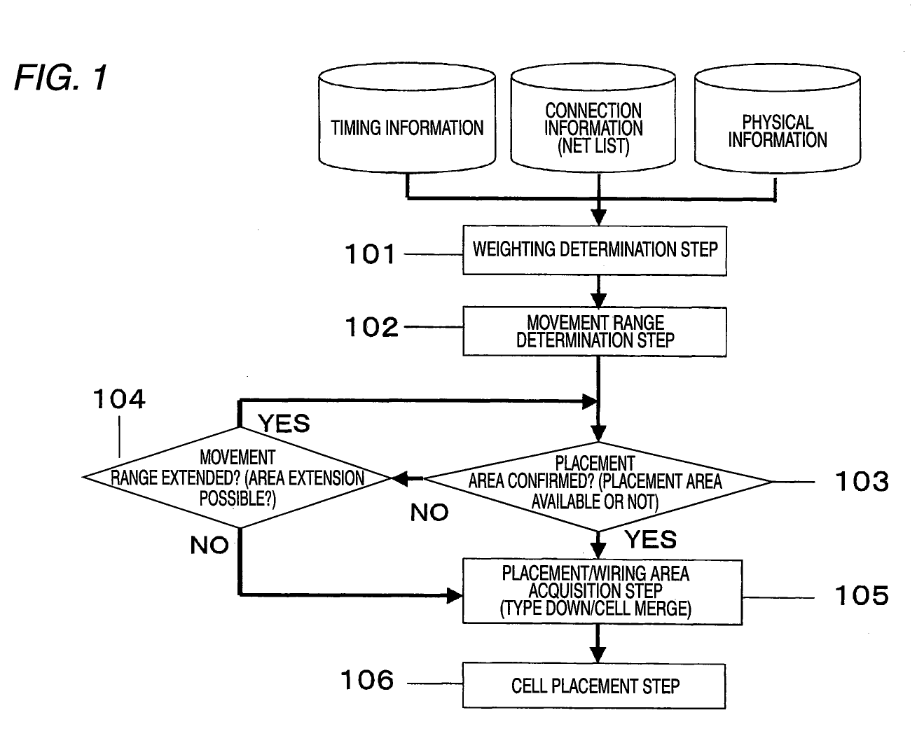

FIG. 1 is a flowchart showing a design method, according to a first embodiment of the present invention, that includes a cell placement method for a semiconductor integrated circuit. This method is characterized by including: a weight determination step 101 of receiving timing information and connection information (hereinafter referred to as a net listing) and of performing a weighting calculation process, while regarding a cell having a small timing margin as a cell that has a greatly enhanced weight, so that movement ranges for cells are reduced when the weightings of the cells are increased; and a cell placement step 106 of employing the results obtained at the weight determination step to place cells. This cell placement step includes the following processing. Weighting of cells is performed while a cell having not only a small timing margin but also an extended Manhattan distance, obtained based on received physical information, is regarded as a cell having a greatly enhanced weight, so that the movement range is reduced for a cell having the greater weight. In addition, while a cell for which many fanouts are obtained, based on the net listing, is regarded as a cell having a greatly enhanced weight, the weighting of cells is performed so that the movement range is reduced for a cell having the greater weight. Then, in accordance with the obtained weighting results, cells are positioned.

Referring to FIG. 1, the cell placement processing performed by the semiconductor integrated circuit design method includes: the weight determination step 101 of receiving timing information, a net listing and physical information, and of determining a weighting in consonance with a timing margin obtained based on the timing information, or on a Manhattan distance or the number of fanouts obtained, based on the net listing or the physical information; a movement range determination step 102 of employing the weighting obtained at the weighting determination step 101 to determine a distance and a range within which a cell can move; a placement confirmation step 103 for confirming that the movement range for a cell is the one obtained at the movement range determination step 102; an area extension step 104 of extending, within the movement range, a movement distance or area at a predetermined ratio and in accordance with the driving capability of a cell; a placement/wiring area acquisition step 105 of obtaining a placement area by performing dimensional reduction or logic reduction through replacement with a low-power driven cell; a cell placement step 106 of performing a placement process. In this embodiment, a weighting calculation process based on a timing margin is defined as a first weighting determination step, a weighting calculation process based on the Manhattan distance is defined as a second weighting determination step, and a weighting calculation process based on the number of fanouts is defined as a third weighting determination step.

When the positions of terminals to be connected after the placement of cells is determined, the shortest signal path to be used to connect these terminals can be calculated. This distance is generally called a Manhattan distance.

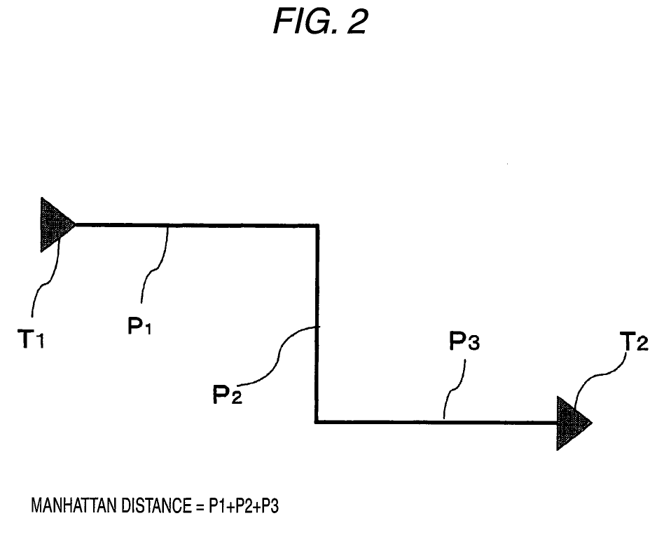

FIG. 2 is an explanatory diagram for the Manhattan distance. When the coordinates of a terminal T1 and a terminal T2 are denoted by (x1, y1) and (x2, y2), a Manhattan distance L to connect these terminals T1 and T2 is provided by the following expression (1).

L=|x2−x1|+|y2−y1| (1)

That is, the Manhattan distance is provided as a length along the shortest path, using the wiring method that employs a wiring grid. However, the path from P1 to P2 to P3 is not the only Manhattan distance path available.

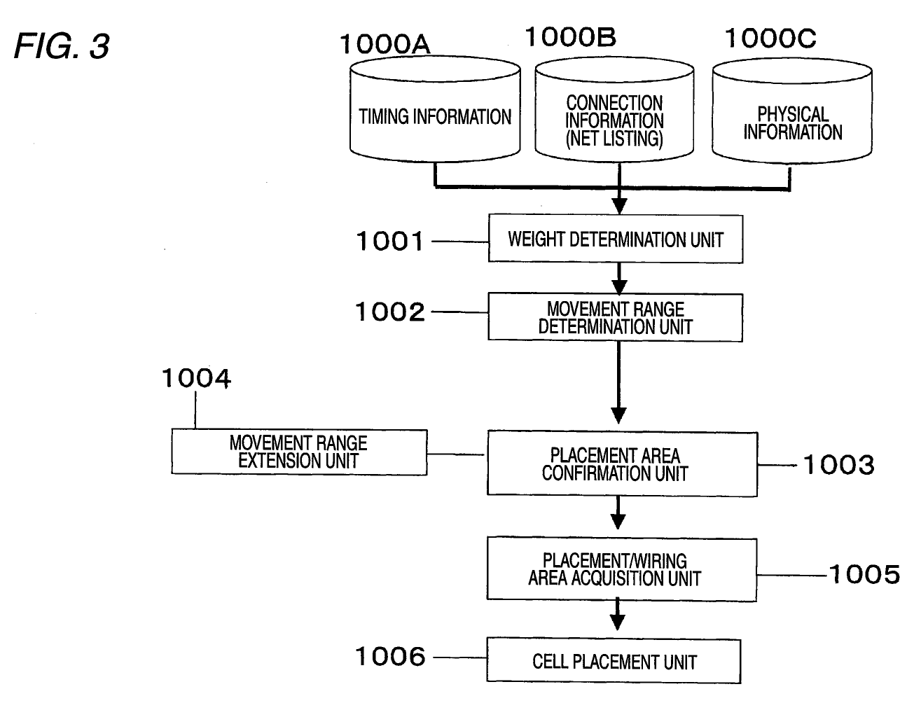

While referring to FIG. 3, a semiconductor integrated circuit design apparatus that performs the processing in FIG. 1 includes: a weight determination unit 1001, for receiving timing information 1000A, a net listing 1000B and physical information 1000C, and for determining a weighting in consonance with a timing margin obtained from the timing information 1000A, or using a Manhattan distance or the number of fanouts obtained from the net listing 1000B or the physical information 1000C; a movement range determination unit 1002, for employing the weighting obtained from the weight determination unit 1001 to determine a distance and a range for the movement of a cell; a placement area confirmation unit 1003, for confirming that the movement range determined by the movement range determination unit 1002 applies to a cell; an area extension unit 1004, for extending, within the movement range, a movement distance or an area at a predetermined ratio and in accordance with the driving capability of a cell; a placement and wiring area acquisition unit 1005, for acquiring a placement area by performing dimensional reduction or logic reduction, through replacement with a low-power driven cell; and a cell placement unit 1006, for performing a placement process.

The weight determination processing will now be described.

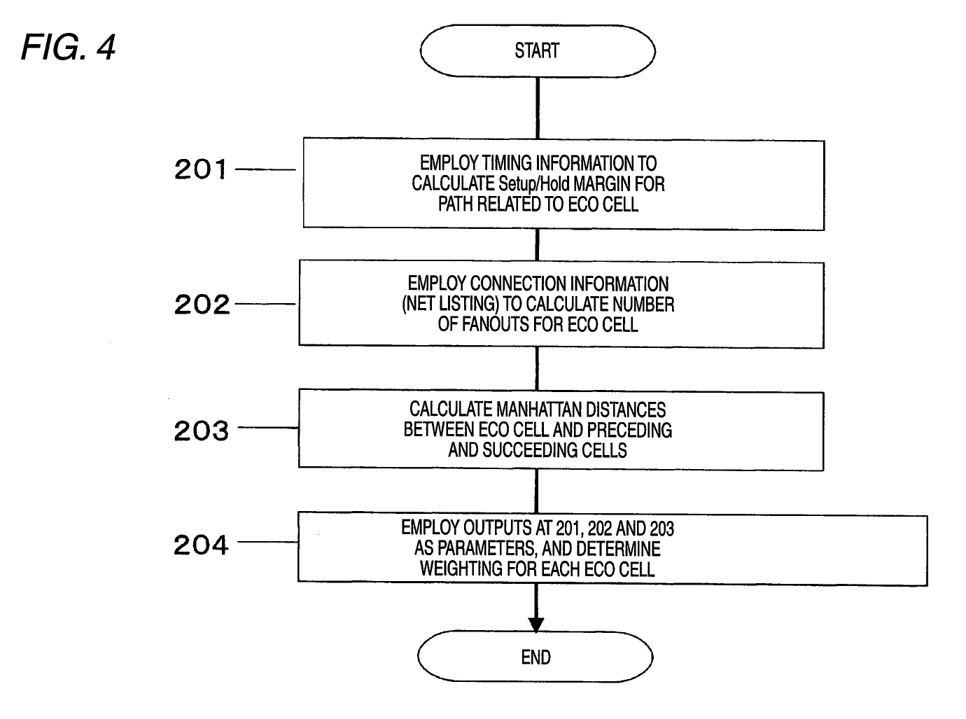

FIG. 4 is a flowchart showing the weight determination processing performed for the second embodiment of the present invention. In FIG. 4, the weight determination processing includes: a step 201 of calculating a timing margin based on timing information obtained by subtracting an ideal time from an arrival time; a step 202 of calculating the number of fanouts based on the net listing; a step 203 of employing the physical information to calculate Manhattan distances before and after terminals are connected; and a step 204 of calculating a weighting based on the results obtained at the steps 201, 202 and 203.

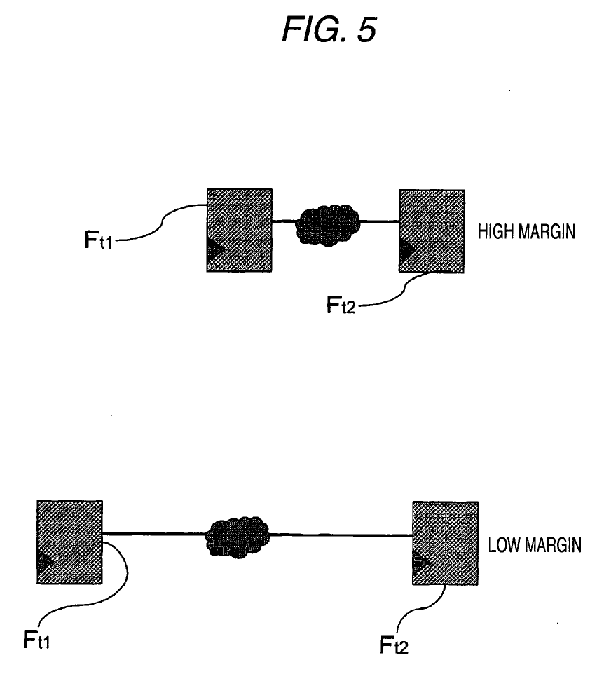

At the weighting determination step 101, timing information includes an ideal signal arrival time and an actual signal arrival time, and a setup holding margin is calculated, based on the timing information, to obtain a timing margin. The timing margin is a time period obtained by subtracting the ideal signal arrival time from the actual signal arrival time, and is represented by nsec. An example timing margin will now be described while referring to FIG. 5. When the distance between flip-flops Ft1 and Ft2 is short, an early signal arrival time is obtained, and when the distance between the flip-flops Ft1 and Ft2 is long, a delayed signal arrival time is obtained. Therefore, for the setup, when flip-flops are near, the timing margin is high, but when the flip-flops are at a distance, the timing margin is low.

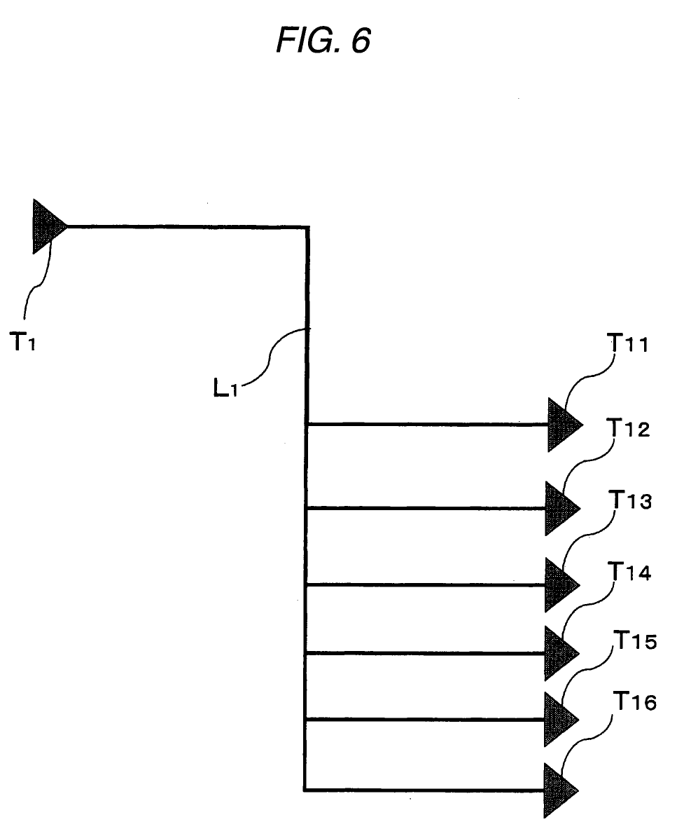

At the fanout calculation step 202, as shown in FIG. 6, the number of fanouts is calculated based on the net listing. In this case, six fan outs T₁₁, T₁₂, T₁₃, T₁₄, T₁₅ and T₁₆ are obtained by employing, as a reference, a line L₁ connected to a terminal T₁.

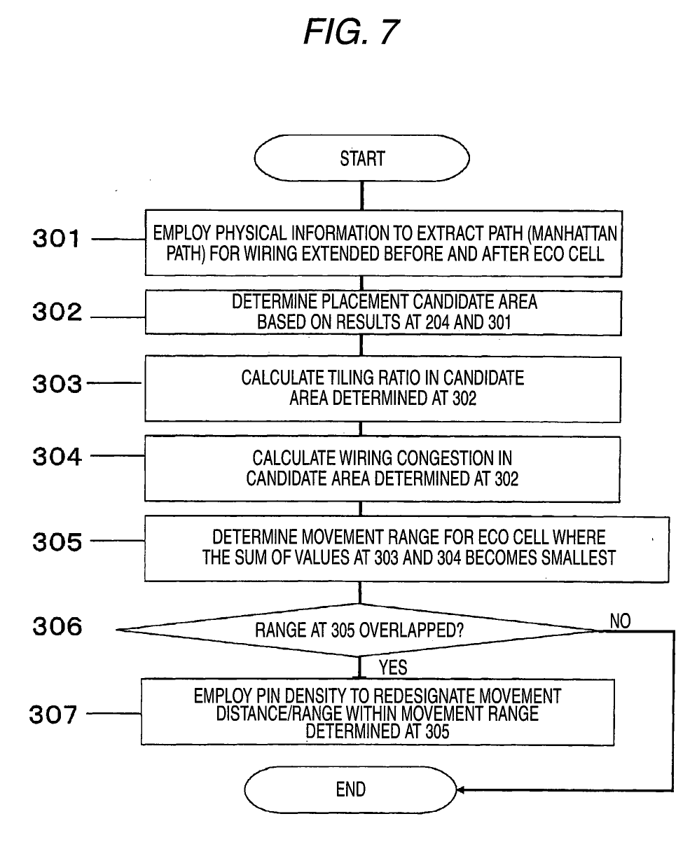

FIG. 7 is a flowchart showing the movement range determination processing. In FIG. 7, the movement range determination processing includes: a step 301 of extracting wiring path information from physical information; a step 302 of employing the results at the steps 204 and 301 to determine a candidate area for cell placement; a step 303 of calculating a cell tiling ratio in the candidate area determined at the step 302; a step 304 of calculating a wiring congestion level in the candidate area determined at the step 302; a step 305 of determining a cell placement/movement range wherein the sum of the values obtained at the steps 303 and 304 is the smallest; a step 306 of determining whether the sum overlaps; and a step 307 of selecting, when the sum overlaps, a movement distance or range in accordance with a pin density within the placement/movement range that is determined at the step 305. When it is determined at the decision step 306 that the sum does not overlap, the processing is terminated, and cells are to be placed in the placement/movement range that is determined at the step 305.

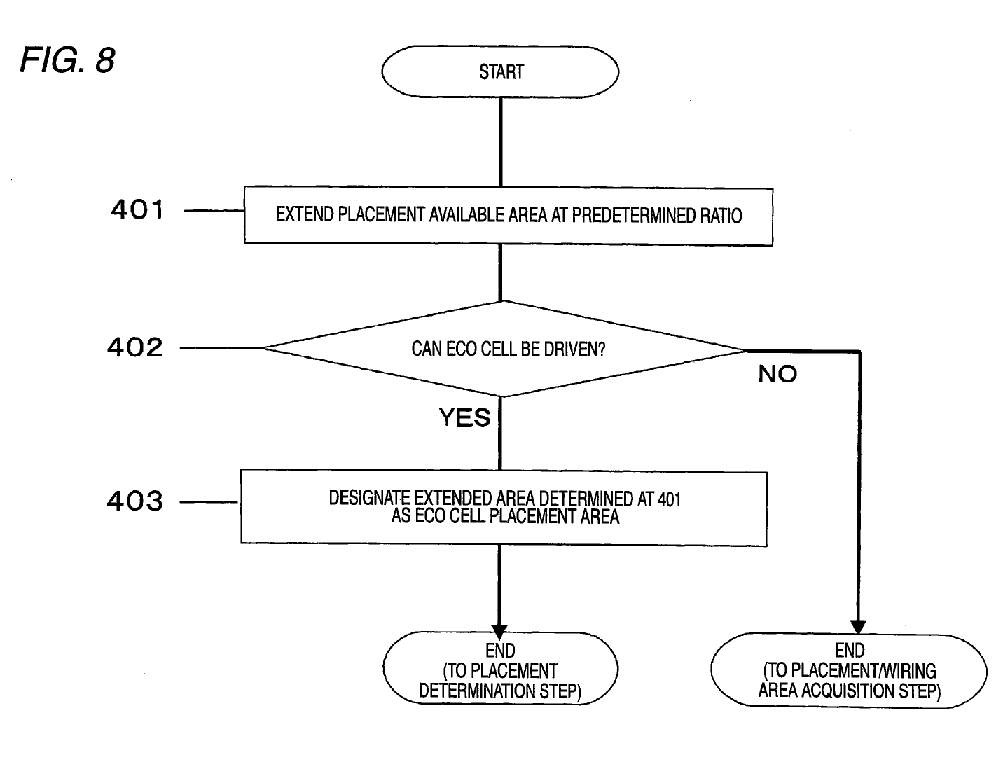

When the movement distance or range has again been designated, the cell movement area extension processing is initiated. FIG. 8 is a flowchart showing the cell movement area extension processing. In FIG. 8, the processing for determining an extension of the movement area includes: a step 401 of extending a cell placement available area at a predetermined ratio based on the placement/movement range determined at the step 306; a step 402 of determining a range limit for a drive cell; and a step 403 of designating, as a cell placement area, the area extended at the step 401.

After the extended area has been designated as a cell placement area, a placement/wiring area is acquired.

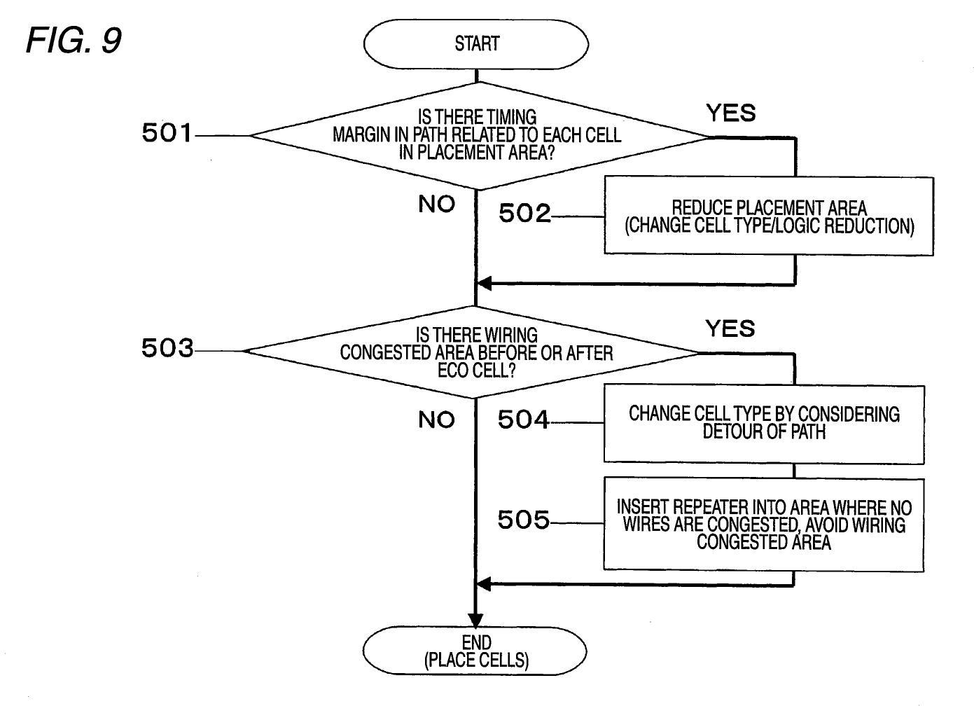

FIG. 9 is a flowchart showing the placement/wiring area acquisition processing of this invention. In FIG. 9, the area acquisition processing includes: a step 501 of determining whether there is a timing margin for a cell in the cell placement area determined at the steps 306 and 403; a step 502 of reducing the size of the placement area by changing a cell type or by performing a logic reduction; a step 503 of determining whether a wiring congested area is preset around the cell placement area; a step 504 of changing a cell type when it is determined at the step 503 that there is a wiring congested area; and a step 505 of inserting a repeater cell into an area wherein there is no wiring congestion to avoid wiring from a wiring congested area.

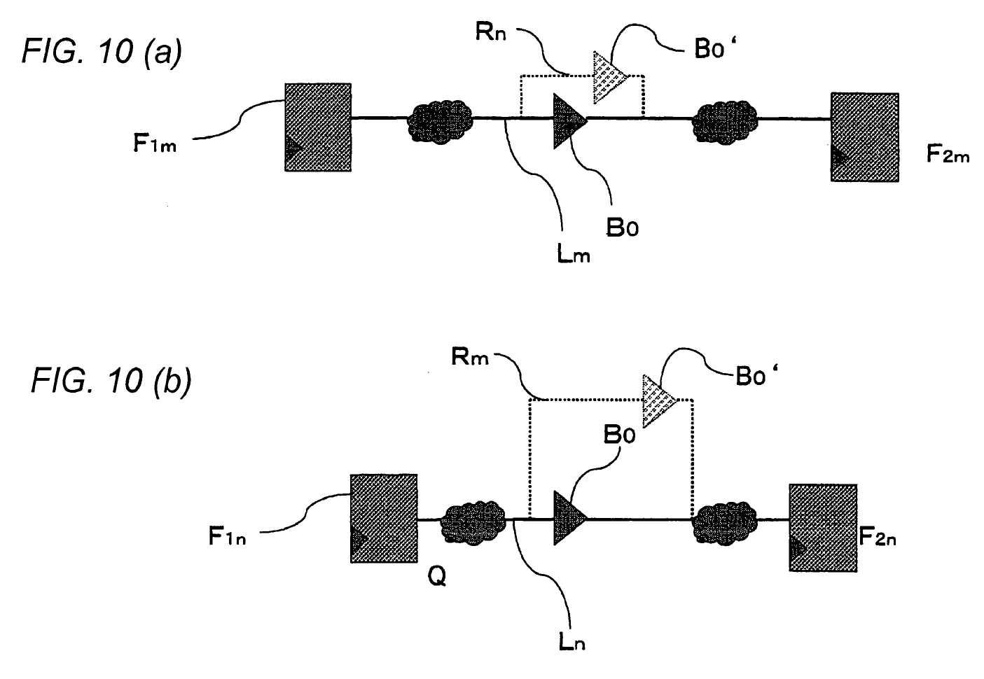

FIGS. 10A and 10B are diagrams showing a movement range for a cell. When a cell B₀, located between flop-flops F₁ₘ and F₂ₘ in FIG. 10A, has a smaller timing margin (a longer Manhattan distance) than a cell B0 located between flop-flops F₁ₙ and F₂ₙ in FIG. 10B, a movement range Rₙ is set smaller than a movement range Rₘ. As described above, the movement range of a cell is changed in accordance with a weighting determined based on a timing margin. Specifically, a threshold value for a weighting is designated, and the movement range for a cell is determined by being compared with the threshold value.

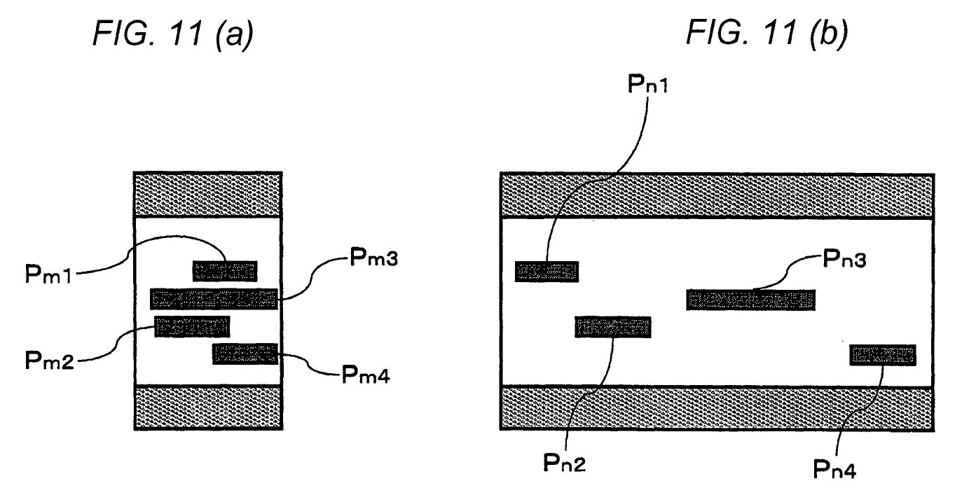

FIGS. 11A and 11B are diagrams showing the densities of pins Pₘ₁ to Pₘ₄ and pins Pₙ₁ to Pₙ₄, which are elements for determining the movement range. The case depicted in FIG. 11A is of a high pin density, while the case depicted in FIG. 11B is of a low pin density.

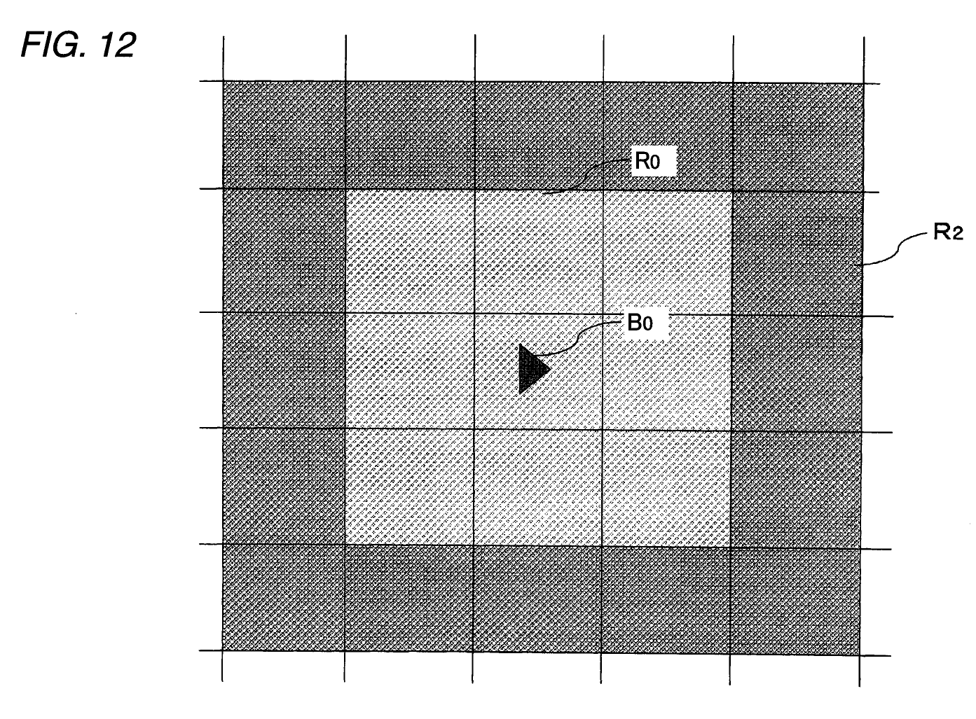

FIG. 12 is a diagram illustrating the state after the movement range has been extended, at a predetermined ratio, at the movement range extension step. While referring to FIG. 12, a movement range R₀ of a targeted cell B₀ is extended to R₂.

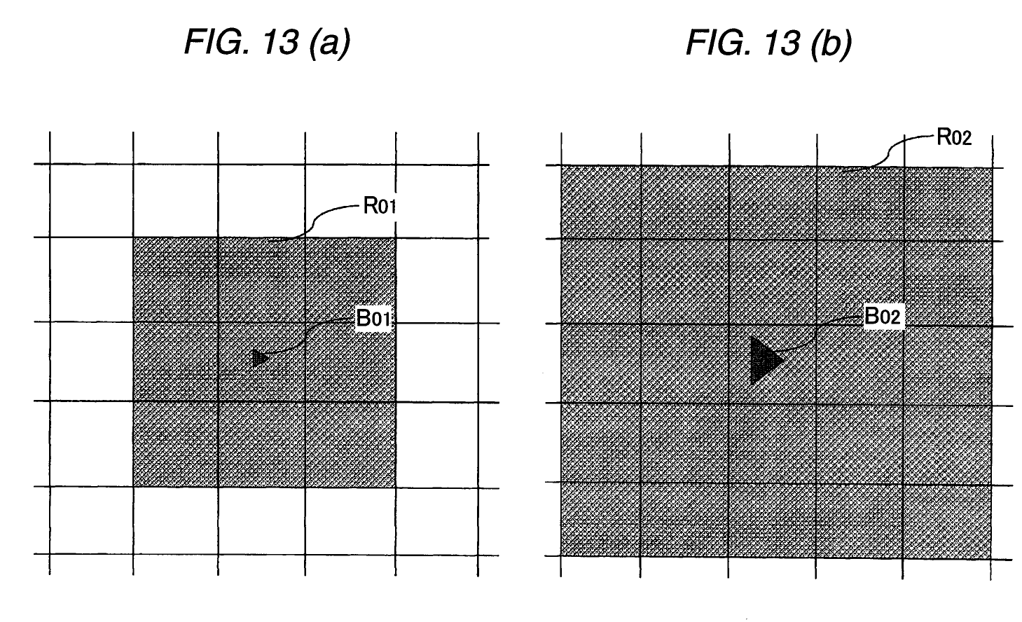

Further, at the movement range extension step, it is preferable that, as shown in FIGS. 13A and 13B, the extension enabled area be changed in accordance with a cell type. Specifically, the movement range is extended in accordance with the weight of a targeted cell, e.g., the movement range for a cell B₀₁ is extended to R₀₁, while the movement range for a cell B₀₂ is extended to R₀₂.

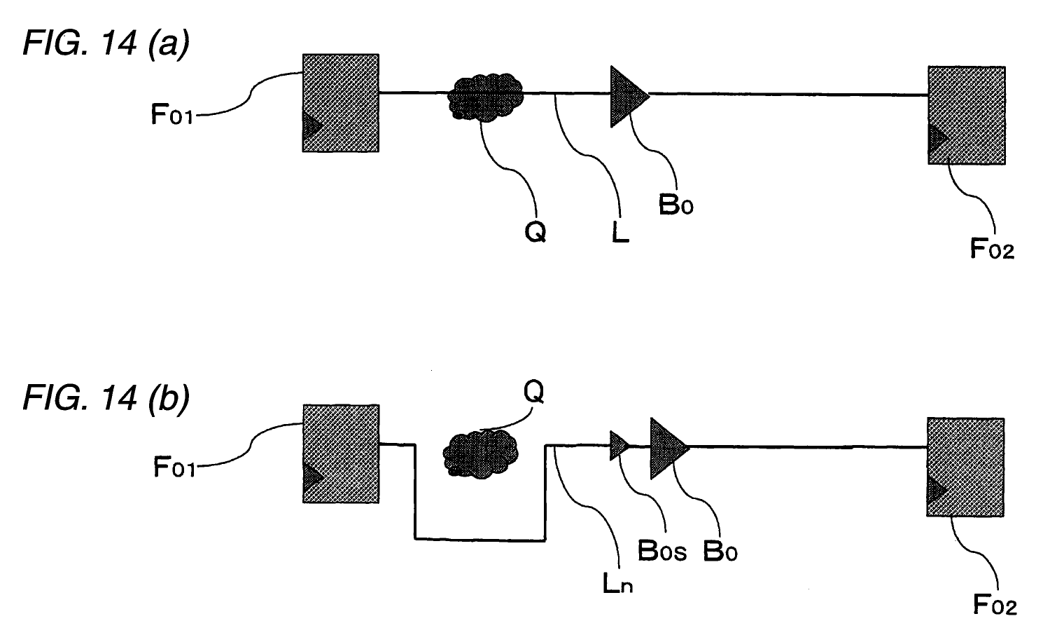

In addition, at the wiring acquisition step, assume that, as shown in FIG. 14A, there is a wiring congested portion Q along a path L, near an ECO targeted cell B₀, that is extended between flip-flops F₀₁ and F₀₂. In this case, as shown in FIG. 14B, a detour path Lₙ is formed and a cell B_{0S}, of a low-power driven type, is inserted near the flip-flop F₀₁. Since a measure for bypassing congestion is considered, using, for example, the above described method for the insertion into a reception side of a low-power driven type cell, a path can be corrected more efficiently.

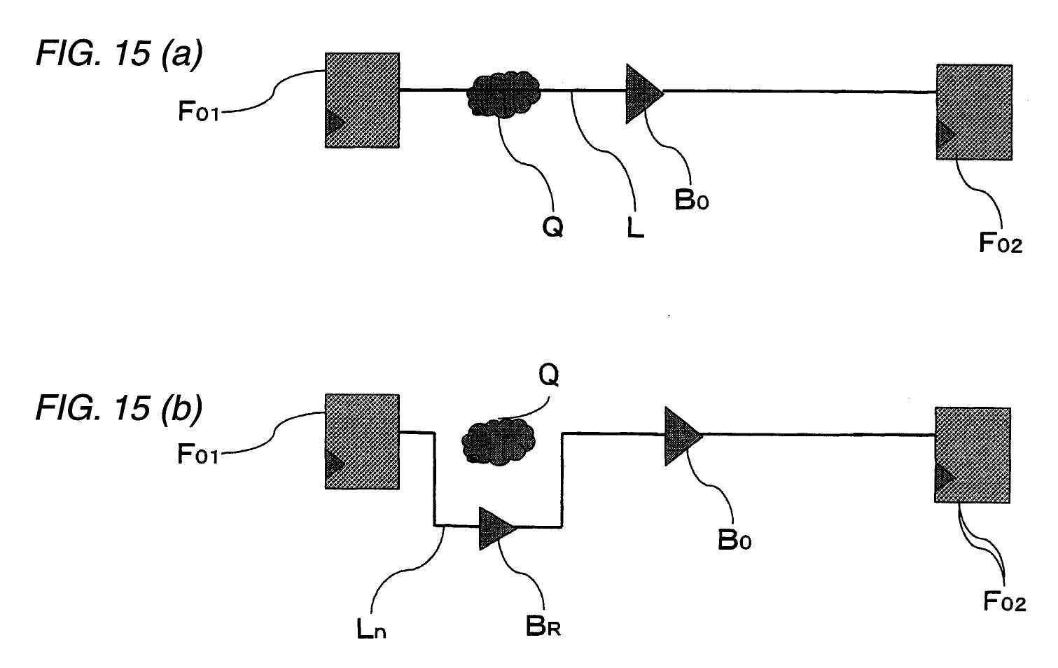

Moreover, at the wiring acquisition step, assume that, as shown in FIG. 15A, there is a wiring congested area Q along a path L, near an ECO targeted cell, that is extended between flip-flops F₀₁ and F₀₂. In this case, as shown in FIG. 15B, a detour path Lₙ is formed and a repeater buffer cell B_{R} is inserted along the detour path Lₙ. Since a measure for bypassing congestion is considered, using, for example, the above described method for inserting a repeater buffer along a detour path, a path can be corrected more efficiently.

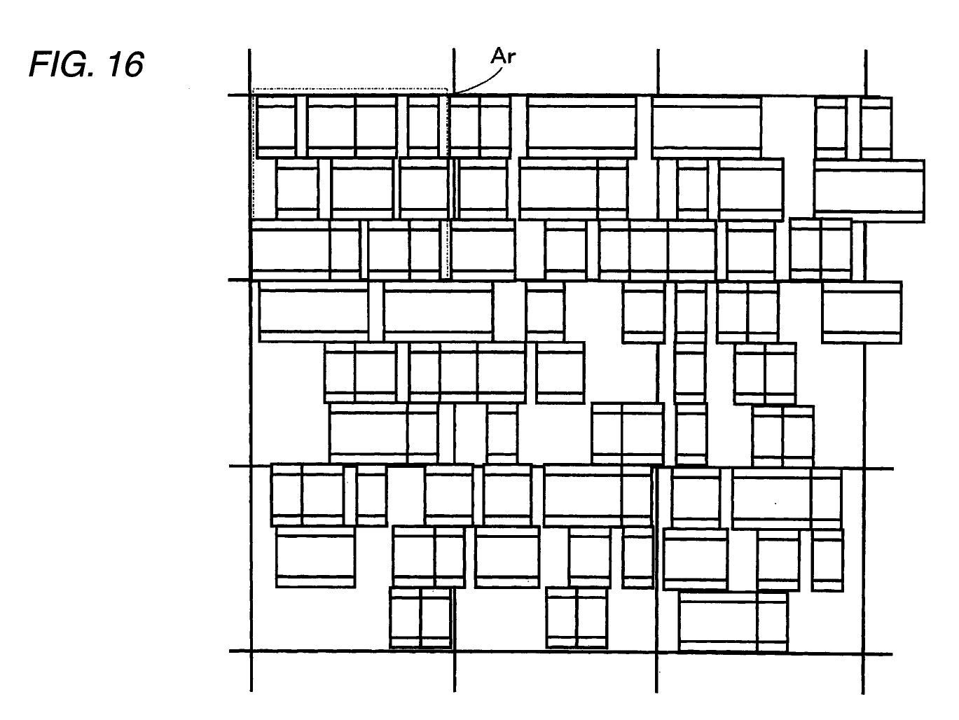

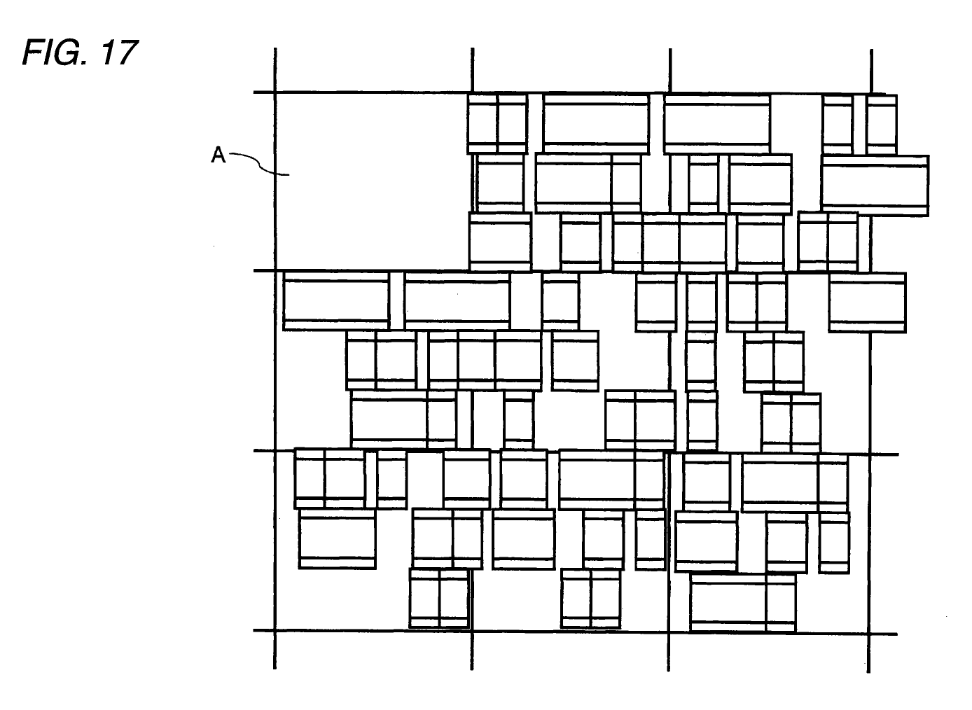

Also, for a case wherein, as shown in FIG. 16, there is an area Ar where cells are closely placed, FIG. 17 is a diagram showing the state wherein, at the placement area acquisition step, cells are deleted from an area wherein cells are closely placed in order to ensure space is available for inserting a new cell.

### Second Embodiment

A second embodiment of the present invention will now be described.

In the first embodiment, cells are weighted based on the timing margin, the Manhattan distance and the number of fanouts, and the obtained weights are added to perform cell placement. According to the second embodiment, the weighting calculation process is performed based only on a timing margin, and cells are to be placed using only the weighting results.

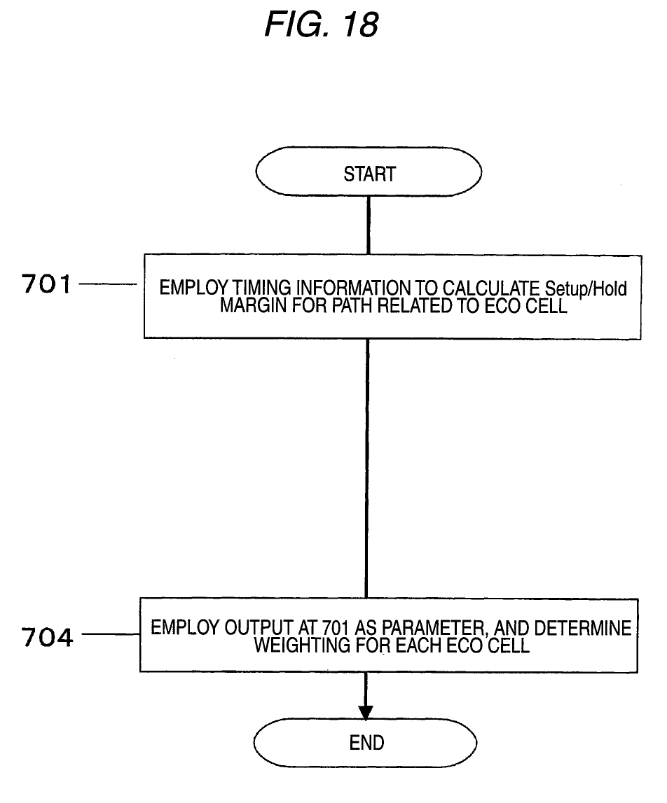

FIG. 18 is a flowchart showing the weight determination processing performed in the second embodiment. The weight determination processing is the same as that in FIG. 4 for the first embodiment, except that the step 202 of calculating the number of fanouts and the step 203 of calculating the Manhattan distance are not included, and the contents of the weighting determination step 204 are different.

While referring to FIG. 18, the weight determination processing for the second embodiment includes: a step 701 of calculating a timing margin based on timing information obtained by subtracting the ideal time from the actual arrival time; and a step 704 of calculating a weighting based on the timing margin obtained at the step 701.

With this arrangement, the processing is extremely simplified.

### Third Embodiment

A third embodiment of the present invention will now be described.

In the first embodiment, cells are weighted based on the timing margin, the Manhattan distance and the number of fanouts, and the obtained weights are added to perform cell placement. In the third embodiment, an explanation will be given for a case wherein the weighting calculation process is performed based only on a timing margin and a Manhattan distance, and cells are to be placed based on the weighting results.

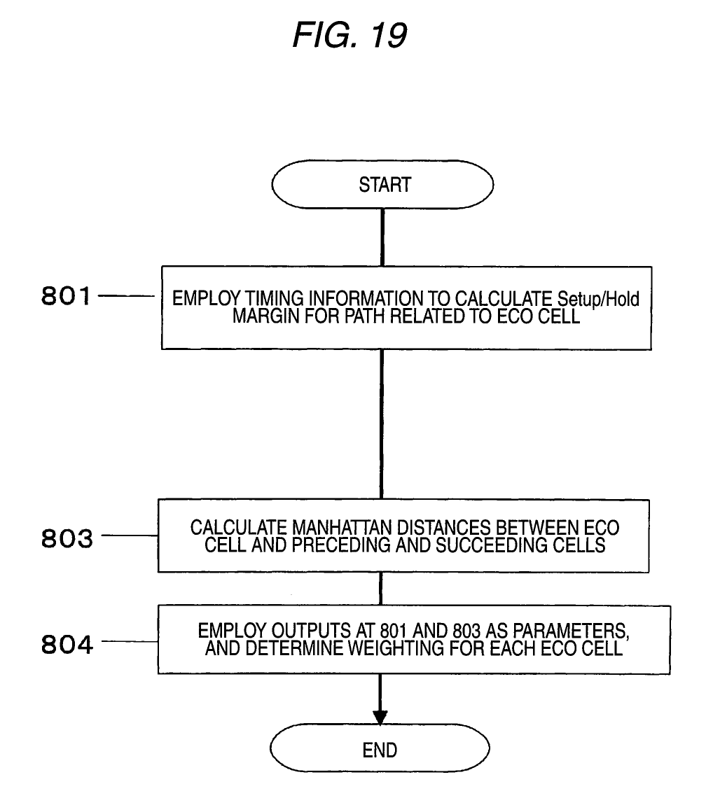

FIG. 19 is a flowchart showing the weight determination processing performed for the third embodiment. The weight determination processing is the same as that shown in FIG. 4 for the first embodiment, except that the step 202 of calculating the number of fanouts is not included, and the contents of the weight determination step 204 are different.

While referring to FIG. 19, the weight determination processing for this embodiment includes: a step 801 of calculating a timing margin based on timing information obtained by subtracting the ideal time from the arrival time; a step 803 of employing physical information to calculate a Manhattan distance before and after connection is established; and a step 804 of calculating a weight based on the results obtained at the steps 801 and 803.

### Fourth Embodiment

A fourth embodiment of this invention will now be described.

In the first embodiment, cells are weighted based on the timing margin, the Manhattan distance and the number of fanouts, and the obtained weights are added to perform cell placement. In the fourth embodiment, an explanation will be given for a case wherein the weighting calculation process is performed based only on a timing margin and the number of fanouts, and cells are to be placed based on the weighting results.

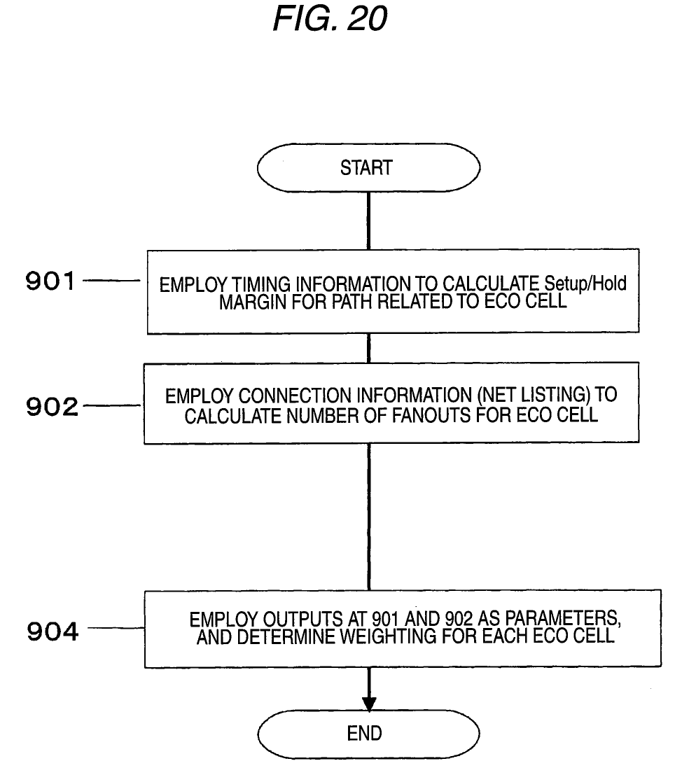

FIG. 20 is a flowchart showing the weighting determination processing performed for the fourth embodiment. This weight determination processing is the same as that in FIG. 4 for the first embodiment, except that the step 203 of calculating the Manhattan distance is not included and the contents of the weighting determination step 204 are different.

While referring to FIG. 20, the weighting determination processing includes a step 901 of calculating a timing margin based on timing information obtained by subtracting the ideal time from the arrival time; a step 902 of calculating the number of fanouts using a net listing; and a step 904 of calculating a weighting based on the results obtained at the steps 901 and 902.

### Fifth Embodiment

A fifth embodiment of the present invention will now be described.

In the first embodiment, cells are weighted based on the timing margin, the Manhattan distance and the number of fanouts, and the obtained weights are added to perform cell placement. According to the fifth embodiment, the weighting calculation process is performed based only on a timing margin, and cells are to be placed using only the weighting results.

FIG. 20 is a flowchart showing the weight determination processing performed in the fifth embodiment. The weight determination processing is the same as that in FIG. 4 for the first embodiment, except that the step 202 of calculating the number of fanouts and the step 203 of calculating the Manhattan distance are not included, and the contents of the weighting determination step 204 are different.

While referring to FIG. 20, the weight determination processing for the third embodiment includes: a step 801 of calculating a timing margin based on timing information obtained by subtracting the ideal time from the actual arrival time; and a step 404 of calculating a weighting based on the timing margin obtained at the step 801.

With this arrangement, the processing is extremely simplified.

The present invention provides for the management of wiring paths when multiple power sources are employed, management of a designated wire passing area, management of a wiring inhibited area and a designated area and a designated wire to be extended in a preferential direction, and is useful for the improvement of wiring closure and simplification of the timing correction operation. According to this invention, the placement method for a semiconductor integrated circuit performs: determination of a weighting based on timing information and physical information; determination of the movement distance or range of a cell based on the weighting for the cell; confirmation of the possibility of placing a cell in the movement range; extension of the range at a predetermined ratio; and the acquisition of a cell placement area. Thus, this method is useful for easily performing a timing correction operation, in addition to preventing the occurrence of wiring congestion. Furthermore, since the required number of steps is reduced and the possibility a so-called setback of the process due to an error caused by manual operation can be avoided, a timing closure can be attained in a shorter period by this method than by the conventional method.

What is claimed is:

1. A design method for a semiconductor integrated circuit comprising:
a first weight determination step of first receiving timing information and connection information (hereinafter referred to as a net listing), and of then performing a weighting calculation process during which a movement range for a cell becomes smaller as the weighting for the cell becomes greater, while weighting is significantly enhanced for a cell for which the timing margin is small; and
a cell placement step of placing a cell in accordance with weighting results obtained at the first weight determination step.

2. The design method for a semiconductor integrated circuit according to claim 1, further comprising:
a second weighting determination step of performing a weighting calculation process during which a movement range for a cell becomes smaller as the weighting for the cell becomes greater, while the weighting is significantly enhanced for a cell for which, based on physical information, a long Manhattan distance is obtained; and
a cell placement step of placing cells in accordance with the weighting results obtained at the second weighting determination step.

3. The design method for a semiconductor integrated circuit according to claim 1, further comprising:
a third weighting determination step of performing a weighting calculation process during which a movement range for a cell becomes smaller as the weighting for the cell becomes greater, while the weighting is significantly enhanced for a cell for which a large number of fanouts is obtained from a net listing at a physical design step for a semiconductor integrated circuit; and
a cell placement step of placing cells in accordance with weighting results obtained at the third weight determination step.

4. The design method for a semiconductor integrated circuit according to claim 1, further comprising:
a setup step of employing the weighting results obtained at least one of the first to the third weight determination steps to designate a permissible value for a movement range for a cell.

5. The design method for a semiconductor integrated circuit according to claim 4, further comprising:
a storage step of storing the movement range designated at the setup step; and
a determination step of searching for an area, within the permissible value designated for the movement range, whereat the tiling ratio of cells becomes smallest, and determining a movement range for a cell, while avoiding a cell or wiring congested area.

6. The design method for a semiconductor integrated circuit according to claim 5, further comprising:
a change step of employing a signal pin density to change the movement range that is determined at the determination step.

7. The design method for a semiconductor integrated circuit according to claim 6, wherein the storage step includes the steps of:
extending the movement range in accordance with a predetermined ratio when an area that satisfies a cell placement condition is not obtained at the change step for changing the movement range based on the signal pin density, and determining an upper limit for the movement range in accordance with the driving capability of a cell; and
determining, within a range extending to the upper limit, a position to which to move the cell.

8. The design method for a semiconductor integrated circuit according to claim 6, further comprising a step of:
when an area that satisfies a placement condition is obtained at the change step, identifying a drive capability for a cell based on an area obtained at the storage area, and changing the drive capability to acquire an area for placing the cell.

9. The design method for a semiconductor integrated circuit according to claim 1, further comprising a step of:
when wiring passes through a congested area, reducing the effectiveness of a cell on a reception side, and placing, adjacent to the cell, another cell having an appropriate driving capability.

10. The design method for a semiconductor integrated circuit according to claim 9, further comprising a step of inserting a repeater cell when a timing margin is high.

11. The design method for a semiconductor integrated circuit according to claim 9, wherein dimensional reduction or logic reduction is performed by preferentially replacing a cell, in a congested location, that has a high timing margin with a low-power driven cell, so that congestion engendered by placing cells is relieved and acquisition of a cell area is ensured.

12. A design apparatus for a semiconductor integrated circuit comprising:
a first weight determination unit for first receiving timing information and connection information, and for then performing a weighting calculation process during which a movement range for a cell becomes smaller as the weighting for the cell becomes greater, while weighting is significantly enhanced for a cell for which the timing margin is small; and
a cell placement unit for placing a cell in accordance with weighting results obtained by the first weight determination unit.

13. The design apparatus for a semiconductor integrated circuit according to claim 12, further comprising:
a second weighting determination unit for performing a weighting calculation process during which a movement range for a cell becomes smaller as the weighting for the cell becomes greater, while the weighting is significantly enhanced for a cell for which, based on physical information, a long Manhattan distance is obtained,
wherein the cell placement unit places cells in accordance with the weighting results obtained by the first weighting determination unit and second weighting determination unit.

14. The design apparatus for a semiconductor integrated circuit according to claim 12, further comprising:
a third weighting determination unit for performing a weighting calculation process during which a movement range for a cell becomes smaller as the weighting for the cell becomes greater, while the weighting is significantly enhanced for a cell for which a large number of fanouts is obtained from a net listing,
wherein the cell placement unit places cells in accordance with the weighting results obtained by the third weight determination unit and the weighting results obtained by either the first or the second weighting determination unit.

15. The design apparatus for a semiconductor integrated circuit according to claim 12, further comprising:
a movement range setup unit for employing the weighting results obtained by at least one of the first to the third weight determination units to designate a permissible value for a movement range for a cell.

16. The design apparatus for a semiconductor integrated circuit according to claim 15, further comprising:
a movement range storage unit for storing the movement range designated by the movement range setup unit; and
a movement range determination unit for searching for an area, within the permissible value designated for the movement range, whereat the tiling ratio of cells becomes smallest, and for determining a movement range for a cell, while avoiding a cell or wiring congested area.

17. The design apparatus for a semiconductor integrated circuit according to claim 16, further comprising:
a movement range change unit for employing a signal pin density to change the movement range that is determined by the movement range determination unit.

18. The design apparatus for a semiconductor integrated circuit according to claim 17, wherein the movement range storage unit includes:
a movement range extension unit for extending the movement range in accordance with a predetermined ratio when an area that satisfies a cell placement condition is not found based on the results obtained by the movement range change unit, and for determining an upper limit for the movement range in accordance with the driving capability of a cell; and
a movement position determination unit for determining, within a range extending to the upper limit, a position to which to move the cell.

19. The design apparatus for a semiconductor integrated circuit according to claim 17, further comprising:
a cell placement unit for, when an area that satisfies a placement condition is obtained by the movement range change unit, identifying a drive capability for a cell based on an area obtained by the movement range storage area, and for changing the drive capability to acquire an area for placing the cell.

20. The design apparatus for a semiconductor integrated circuit according to claim 12, wherein, when wiring passes through a congested area, the cell placement unit reduces the effectiveness of a cell on a reception side, and places, adjacent to the cell, another cell having an appropriate driving capability.

21. The design apparatus for a semiconductor integrated circuit according to claim 20, wherein the cell placement unit inserts a repeater cell when a timing margin is high.

22. The design apparatus for a semiconductor integrated circuit according to claim 20, wherein dimensional reduction or logic reduction is performed by preferentially replacing a cell, in a congested location, that has a high timing margin with a low-power driven cell, so that congestion engendered by placing cells is relieved and acquisition of a cell area is ensured.
